(19) United States
(12) Patent Application Publication
(10) Pub. No.: US 2023/0017833 A1
(43) Pub. Date: Jan. 19, 2023

(54) COATED SOFT MAGNETIC ALLOY PARTICLE, DUST CORE, MAGNETIC APPLICATION COMPONENT, AND METHOD FOR PRODUCING COATED SOFT MAGNETIC ALLOY PARTICLE

(71) Applicant: Murata Manufacturing Co., Ltd., Kyoto-fu (JP)

(72) Inventors: Luan JIAN, Nagaokakyo-shi (JP); Masashi INOGUCHI, Nagaokakyo-shi (JP); Kenji SAKAGUCHI, Nagaokakyo-shi (JP)

(73) Assignee: Murata Manufacturing Co., Ltd., Kyoto-fu (JP)

(21) Appl. No.: 17/934,518

(22) Filed: Sep. 22, 2022

Related U.S. Application Data
(63) Continuation of application No. PCT/JP2021/009355, filed on Mar. 9, 2021.

(30) Foreign Application Priority Data
Mar. 31, 2020 (JP) 2020-064422

(51) Int. Cl. H01F 1/20; H01F 27/255; C22C 45/02; B22F 1/16; B22F 1/14

(52) U.S. Cl. CPC H01F 1/20; B22F 1/14; B22F 1/16; C22C 45/02; H01F 27/255; B22F 2301/35; B22F 2302/25; B22F 2302/45; C22C 2200/02; C22C 2202/02

(57) ABSTRACT

A coated soft magnetic alloy particle includes a soft magnetic alloy particle containing an amorphous phase, and a first film containing at least one compound selected from the group consisting of an inorganic compound having a hexagonal, trigonal, or monoclinic crystal structure and a layered silicate mineral. The first film coats a surface of the soft magnetic alloy particle, and an outer peripheral contour of a section of the coated soft magnetic alloy particle has an average smoothness ζ_ave of 0.92 or more and 1.00 or less (i.e., from 0.92 or more and 1.00).

### CROSS-REFERENCE TO RELATED APPLICATIONS

This application claims benefit of priority to International Patent Application No. PCT/JP2021/009355, filed Mar. 9, 2021, and to Japanese Patent Application No. 2020-064422, filed Mar. 31, 2020, the entire contents of each are incorporated herein by reference.

### BACKGROUND

### Technical Field

The present disclosure relates to a coated soft magnetic alloy particle, a dust core, a magnetic application component, and a method for producing a coated soft magnetic alloy particle.

### Background Art

Magnetic application components such as motors, reactors, inductors, and various coils are required to operate with high efficiency and at a large current. Thus, a soft magnetic material used for an iron core (dust core) of a magnetic application component is required to have a low iron loss and a high saturation magnetic flux density. In general, iron loss includes hysteresis loss and eddy current loss, and a dust core having a small eddy current loss is desired to drive magnetic application components at a high frequency against the background of miniaturization of magnetic application components.

A dust core contains at least soft magnetic particles made of a soft magnetic material, and further contains a binder, a lubricant, and the like as necessary. The higher the electrical resistance between the soft magnetic material contained in the dust core, the smaller the eddy current loss. In addition, the higher the space filling rate of the soft magnetic material in the dust core, the higher the magnetic permeability of the coil can be, and the higher the saturation magnetic flux density can be, which is preferable.

A nanocrystal material containing an amorphous phase in a soft magnetic material is suitable to reduce the iron loss while sufficiently increasing the saturation magnetic flux density. As a method for producing a nanocrystal material, an atomization method as described in WO 2019/031463 A and a pulverization method Japanese Patent Application Laid-Open No. 2018-50053 are disclosed.

### SUMMARY

However, the method described in WO 2019/031463 has a problem that the average particle size of the nanocrystal material that can be produced is small and the saturation magnetic flux density is small.

The method described in Japanese Patent Application Laid-Open No. 2018-50053 is a method for producing soft magnetic particles by pulverizing a ribbon formed by a liquid quenching method. In the liquid quenching method, the saturation magnetic flux density can increase since the cooling rate is high, but the particle shape of the soft magnetic particles is not spherical but flat. Thus, there is a problem that the space filling rate of the soft magnetic particles decreases when the soft magnetic particles are formed into a dust core.

In addition, when the soft magnetic particles were produced by pulverizing the ribbon, irregularities (edges) were formed on the surface of the flat soft magnetic particles.

Further, when the space filling rate of the soft magnetic particles in the dust core is low, the magnetic permeability of the dust core is low, and at the same time, the contact area between the soft magnetic particles is small, and there is a problem that the stress at the time of molding concentrates on the contact point between the soft magnetic particles and the iron loss increases.

Accordingly, the present disclosure provides soft magnetic alloy particles capable of increasing the space filling rate of the soft magnetic particles and decreasing the iron loss when the soft magnetic alloy particles are formed into a dust core.

A coated soft magnetic alloy particle includes a soft magnetic alloy particle containing an amorphous phase, and a first film containing at least one compound selected from the group consisting of an inorganic compound having a hexagonal, trigonal, or monoclinic crystal structure and a layered silicate mineral. The first film coats a surface of the soft magnetic alloy particle, and an outer peripheral contour of a section of the coated soft magnetic alloy particle has an average smoothness ζ_ave of 0.92 or more and 1.00 or less (i.e., from 0.92 to 1.00).

A dust core of the present disclosure includes the coated soft magnetic alloy particle of the present disclosure.

A magnetic application component of the present disclosure includes the coated soft magnetic alloy particle of the present disclosure or includes the dust core of the present disclosure.

A method for producing a coated soft magnetic alloy particle of the present disclosure includes a step of preparing a soft magnetic alloy particle, and a step of forming a first film on a surface of the soft magnetic alloy particle by mixing the soft magnetic alloy particle with at least one compound selected from the group consisting of an inorganic compound having a hexagonal, trigonal, or monoclinic crystal structure and a layered silicate mineral to form a mixture and treating the mixture by a mechanofusion process.

The present disclosure can provide soft magnetic alloy particles capable of increasing the space filling rate of the soft magnetic particles and reducing the iron loss when the soft magnetic alloy particles are formed into a dust core.

### BRIEF EXPLANATION OF DRAWINGS

FIG. 1 is a sectional view schematically illustrating an example of a coated soft magnetic alloy particle of the present disclosure;

FIG. 2 is an explanatory diagram of the average smoothness of a particle;

FIG. 3 is a schematic sectional view of a coating device used for a treatment by a mechanofusion process;

FIG. 4 is a perspective view schematically illustrating an example of a coil as a magnetic application component;

FIG. 5 is an electron micrograph of a coated soft magnetic alloy particle of the sample No. 2;

FIG. 6 is an electron micrograph of a soft magnetic alloy particle of the sample No. 6; and

FIG. 7 is an electron micrograph of a coated soft magnetic alloy particle of the sample No. 1.

### DETAILED DESCRIPTION

Hereinafter, a coated soft magnetic alloy particle, a dust core, a magnetic application component, and a method for producing a coated soft magnetic alloy particle of the present disclosure will be described.

The present disclosure is not limited to the following configurations and may be appropriately modified and applied without changing the spirit of the present disclosure. The present disclosure also includes a combination of two or more of individual preferable configurations of the present disclosure described below.

### Coated Soft Magnetic Alloy Particle

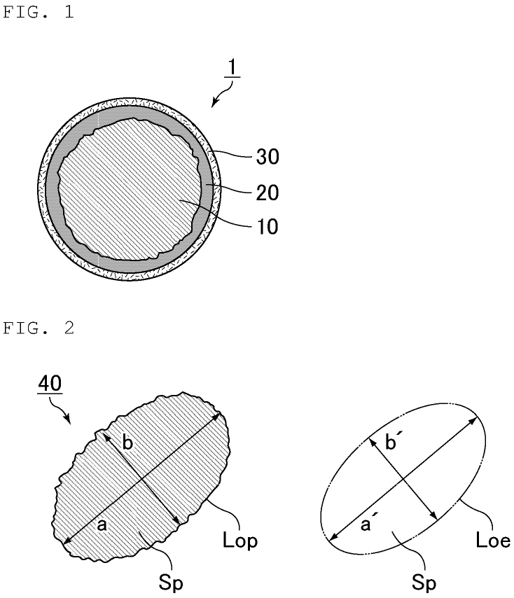

FIG. 1 is a sectional view schematically illustrating an example of a coated soft magnetic alloy particle of the present disclosure.

A coated soft magnetic alloy particle 1 illustrated in FIG. 1 includes a soft magnetic alloy particle 10, a first film 20 coating the surface of the soft magnetic alloy particle 10, and a second film 30 coating the surface of the second film.

Irregularities (edges) are formed on the surface of the soft magnetic alloy particle 10, and the irregularities are filled with the first film 20 to be smoothed. The surface of the coated soft magnetic alloy particle 1 after the second film 30 is formed on the surface of the first film 20 is also smooth.

The coated soft magnetic alloy particle of the present disclosure has an average smoothness ζ_ave of a section of 0.92 or more and 1.00 or less (i.e., from 0.92 to 1.00). The average smoothness will be described with reference to the drawings.

FIG. 2 is an explanatory diagram of the average smoothness of a particle.

A sectional shape of a particle 40 is illustrated on the left side of FIG. 2. Lop represents the total circumferential length of the contour of the particle 40. The total circumferential length Lop is obtained as a total circumferential length II obtained from manual analysis using image analysis software (for example, WinROOF2018: manufactured by MITANI CORPORATION).

The major axis of the particle is defined as a, and the diameter orthogonal to the major axis a is defined as a minor axis b. The image area of the particle is Sp.

On the right side of FIG. 2, an ellipse in which the major/minor ratio λ of the two-dimensional projection image of the particle 40 is equal to the image area Sp of the particle 40 is drawn by a dotted line. The value itself of the length of a major axis a′ and the length of a minor axis b′ of the ellipse is different from that of the major axis a and the minor axis b. The total circumferential length of the ellipse is defined as Loe. The ratio of Loe to Lop = Loe/Lop is set as a smoothness ζ.

The smoothness ζ is 1 when the particle is a circle or an ellipse without irregularities but is less than 1 when the surface has irregularities. The smoothness ζ is measured for any 20 particles taken in an electron micrograph of the coated soft magnetic alloy particles, and an average value is taken to determine an average smoothness ζ_ave.

When the average smoothness ζ_ave is 0.92 or more and 1.00 or less (i.e., from 0.92 to 1.00), it is determined that the particles have a high surface smoothness. The average smoothness ζ_ave of the coated soft magnetic alloy particles is preferably 0.92 or more and 0.94 or less (i.e., from 0.92 to 0.94).

When coated soft magnetic alloy particles having a high average smoothness is used, space formation due to the presence of irregularities on the surface of the particles hardly occurs. Thus, when the soft magnetic alloy particles are formed into a dust core, it is possible to increase the space filling rate of the soft magnetic alloy particles and reduce the iron loss.

The soft magnetic alloy particles are particles containing an amorphous phase. The soft magnetic alloy particles are preferably nanocrystalline materials having an amorphous phase. The nanocrystal material is a material mainly composed of fine crystal grains having an average crystal grain size of 30 nm or less.

The average crystal grain size of the crystals contained in the soft magnetic alloy particles is related to the coercive force, and the coercive force exhibits a maximum value with respect to the average crystal grain size. For example, the maximum value appears in the vicinity of 50 nm to 100 nm. Since the coercive force has a strong correlation proportional to the negative sixth power of the average crystal grain size on the smaller grain size side than the crystal grain size showing the maximum value, it is effective to reduce the crystal grain size to reduce the coercive force.

The nanocrystalline material may be obtained by crystallizing an amorphous phase. Since the amorphous phase is a metastable phase, crystal nuclei are generated and grown by heating at a temperature equal to or higher than the crystallization starting temperature, heating for a long time, or the like.

For example, in a Fe-based nanocrystal material, Fe is preferably substituted with at least one element selected from the group consisting of, for example, B, P, C, and Si to form an amorphous phase. In addition, it is preferable to substitute Fe with Cu to promote crystal nucleation.

Further, Fe may be substituted with at least one element selected from the group consisting of, for example, Nb, Mo, Zr, Hf, Ta, and W to inhibit crystal grain growth and generate a lot of fine crystal grains. Fe may be substituted with at least one element selected from the group consisting of Ni and Co to adjust saturation magnetization and magnetostriction.

Since the type and amount of the solute element that can be solid dissolved in Fe are limited, when the crystallization of the amorphous phase proceeds, the solute element diffuses into the amorphous phase, and the thermal stability of the amorphous phase increases. The amorphous phase thus remains after crystallization.

The presence or absence of the amorphous phase may be confirmed by acquiring an electron beam diffraction pattern of a local part using a transmission electron microscope. A nanobeam deflection method is preferable because the method has a high measurement accuracy. Alternatively, the presence or absence of the amorphous phase may be confirmed by the presence or absence of the halo pattern derived from the amorphous structure in the vicinity of 2θ = 44° from an X-ray diffraction profile measured by a θ-2θ method with an X-ray diffractometer.

The chemical composition of the soft magnetic alloy particles based on the above is not particularly limited, but a metal material containing Fe as a main component is preferable, and specifically, a pure iron-based soft magnetic material (electromagnetic soft iron), an Fe-based alloy, an Fe-Si–based alloy, an Fe-Ni–based alloy, an Fe-Al–based alloy, an Fe-Si-Al–based alloy, an Fe-Si-Cr–based alloy, an Fe-Ni-Si-Co–based alloy, or an Fe-based amorphous alloy is more preferable.

Examples of the Fe-based amorphous alloy include a Fe-Si-B–based amorphous alloy and a Fe-Si-B-Cr-C-based amorphous alloy. As the metal material, one type may be used, or two or more types may be used in combination.

The soft magnetic alloy particle preferably has a chemical composition represented by FeₐSi_{b}B_{c}C_{d}PₑCu_{f}Sn_{g}M1ₕM2ᵢ. In the chemical composition, a + b + c + d + e + f + g + h + i = 100 (parts by mol) is satisfied.

A part of Fe may be substituted with M1 which is one or more elements of Co and Ni. In such a case, the content of M1 is preferably 30 atom% or less of the total of the chemical composition. M1 thus satisfies 0 ≤ h ≤ 30.

A part of Fe may be substituted with M2 which is one or more elements of Ti, Zr, Hf, Nb, Ta, Mo, W, Cr, Al, Mn, Ag, V, Zn, As, Sb, Bi, Y, and a rare earth element. In such a case, the content of M2 is preferably 5 atom% or less of the total of the chemical composition. M2 thus satisfies 0 ≤ i ≤ 5.

A part of Fe may be substituted with both M1 and M2. The sum of Fe, M1, and M2 satisfies 79 ≤ a + h + i ≤ 86.

The proportion of Si satisfies 0 ≤ b ≤ 5, and preferably satisfies 0 ≤ b ≤ 3.

The proportion of B satisfies 4 ≤ c ≤ 13.

The proportion of C satisfies 0 ≤ d ≤ 3. It is more preferable that the proportion satisfy 0.1 ≤ d ≤ 3.

The proportion of the total of B and C satisfies 5 ≤ c + d ≤ 14.

The proportion of P satisfies 1 ≤ e ≤ 10.

The proportion of Cu satisfies 0.4 ≤ f < 2.

The proportion of Sn satisfies 0.3 ≤ g ≤ 6.

The soft magnetic alloy particle may further contain S (sulfur) in an amount of 0.1 wt% or less based on 100 wt% of the total of the component having the above chemical composition.

The first film includes at least one compound selected from the group consisting of an inorganic compound having a hexagonal, trigonal, or monoclinic crystal structure, and a layered silicate mineral. The first film is preferably an inorganic compound having a property of peeling in a layer form.

Examples of the inorganic compound having a hexagonal, trigonal, or monoclinic crystal structure include sulfides such as hexagonal boron nitride (h-BN), zirconium disulfide (ZrS₂), vanadium disulfide (VS₂), niobium disulfide (NbS₂), molybdenum disulfide (MoS₂), tungsten disulfide (WS₂), and rhenium disulfide (ReS₂), selenides such as tungsten selenide (WSe), molybdenum selenide (MoSe), and niobium selenide (NbSe), graphite, cadmium chloride (CdCl₂), and cadmium iodide (CdI₂). Among them, molybdenum disulfide (MoS₂) is preferable.

Examples of the layered silicate mineral include mica, biotite, chlorite, illite, lepidolite, zinnwaldite, talc, and pyrophyllite.

The inorganic compound and the layered silicate mineral have a property of peeling in a layer form or being brittlely fractured in a layer form when a stress is applied. Thus, when they are mixed with the soft magnetic alloy particles and subjected to a stress, the fragments that are produced when the inorganic compound and the layered silicate mineral are caught by the bumps on the surface of the soft magnetic alloy particles and peeled or broken fill the dips on the surface of the soft magnetic alloy particles. By further continuing the mixing and the stress application, a particle having a smooth surface in which the surface of the soft magnetic alloy particle is coated with the first film is formed.

The first film functions as an insulating film of the soft magnetic alloy particle. Increasing the insulating properties of the soft magnetic alloy particles causes the electrical resistance between the soft magnetic alloy particles to increase, which can reduce the eddy current loss.

The coated soft magnetic alloy particle preferably further includes a second film containing an oxide, the second film coating a surface of the first film. When the coated soft magnetic alloy particle further includes the second film, the electrical resistance between the soft magnetic alloy particles can increase, and the eddy current can further decrease.

The oxide contained in the second film is preferably an oxide containing silicon, and more preferably silicon dioxide (SiO₂). That is, the second film preferably contains silicon oxide. Silicon dioxide is preferable as the second film because it has high insulation resistance and high film strength.

The average particle size of the soft magnetic alloy particles is preferably 10 µm or more and preferably 50 µm or less (i.e., from 10 µm to 50 µm).

The average thickness of the first film is preferably 50 nm or more and preferably 400 nm or less (i.e., from 50 nm to 400 nm). When the average thickness of the first film is 50 nm or more, the effect of smoothing irregularities on the surface of the soft magnetic alloy particles is suitably exhibited. When the average thickness of the first film is too large, magnetic interaction between the soft magnetic alloy particles is inhibited, and therefore, the average thickness of the first film is preferably 400 nm or less.

The average thickness of the second film is preferably 10 nm or more and preferably 300 nm or less (i.e., from 10 nm to 300 nm). The average particle size of the coated soft magnetic alloy particles is preferably 10 µm or more and preferably 55 µm or less (i.e., from 10 µm to 55 µm).

The average particle size of the soft magnetic alloy particles and the average particle size of the coated soft magnetic alloy particles may be measured by a laser diffraction/scattering type particle size and particle size distribution measuring apparatus.

### Method for Producing Coated Soft Magnetic Alloy Particle

First, soft magnetic alloy particles are prepared. Such soft magnetic alloy particles may be produced, for example, as follows.

A raw material (soft magnetic alloy) weighed to have a predetermined chemical composition is heated and melted to prepare a molten metal, and the molten metal is cooled to obtain a ribbon. A cooling and solidifying method and conditions with a high cooling rate are preferable to produce a ribbon containing an amorphous phase.

A stress is applied to the obtained ribbon to produce a pulverized powder. The pulverization method is not particularly limited, and examples thereof include pin milling, hammer milling, feather milling, sample milling, ball milling, and stamp milling.

By plastically deforming the pulverized powder by simultaneously applying a shear stress and a compressive stress to the pulverized powder, particles having a shape close to a spherical shape may be produced. The pulverizer is not particularly limited, but for example, a high-speed rotary pulverizer such as a hybridization system (manufactured by Nara Machinery Co., Ltd.) is preferable. A condition in which a stress is applied to a contact point between the soft magnetic alloy particles and a plurality of particles are aggregated into a single particle is preferable because soft magnetic alloy particles having a shape close to a spherical shape can be obtained.

A commercially available powder [for example, Fe-based amorphous alloy powder (manufactured by Epson Atmix Corporation)] may be prepared as the soft magnetic alloy particles.

As the soft magnetic alloy particles, it is preferable to use the soft magnetic alloy particles in which coarse particles and microparticles are removed using two types of sieves having different sieve sizes to make the particle sizes uniform.

Next, the first film is formed on the surface of the soft magnetic alloy particles.

When the first film is formed, the soft magnetic alloy particles are mixed with at least one compound (hereinafter, also referred to as a compound for the first film) selected from the group consisting of an inorganic compound having a hexagonal, trigonal, or monoclinic crystal structure, and a layered silicate mineral, and the mixture is treated by a mechanofusion process.

In the treatment by a mechanofusion process, the soft magnetic alloy particles and the compound for the first film are put into a container and mixed while a mechanical impact force is applied.

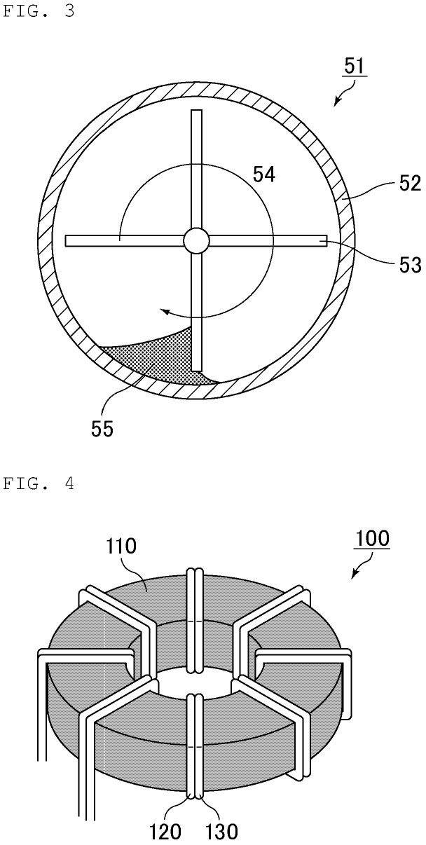

FIG. 3 is a schematic sectional view of a coating device used for the treatment by a mechanofusion process.

A coating device 51 illustrated in FIG. 3 includes a chamber 52 having a cylindrical section and is configured such that a blade 53 rotates as indicated by an arrow 54 in the chamber 52. A workpiece 55 (the soft magnetic alloy particles and the compound for the first film) is put into the chamber 52, and in this state, the blade 53 rotates to treat the workpiece 55.

Examples of the coating device as described above include a powder processing device (NOB, NOB-MINI) manufactured by Hosokawa Micron Corporation. Through this treatment, irregularities on the surface of the soft magnetic alloy particles are filled with the compound for the first film, and the surface of the first film becomes a smooth surface.

Preferable conditions for obtaining a smooth surface include that the blending amount of the compound for the first film is an amount sufficient for filling irregularities on the surface of the soft magnetic alloy particles. The blending amount of the first film compound is preferably 0.30 wt% or more, and more preferably 0.60 wt% or more with respect to 100 wt% of the soft magnetic alloy particles.

The average particle size of the compound for the first film is preferably 500 nm or less. The rotation speed of the blade in the coating device is preferably, for example, 1 rpm or more and 10,000 rpm or less (i.e., from 1 rpm to 10,000 rpm). The processing time is preferably 1 minute or more and 60 minutes or less (i.e., from 1 minute to 60 minutes).

The coated soft magnetic alloy particle of the present disclosure can be produced by the above procedure.

After the first film is formed, the soft magnetic alloy particles are heated to a temperature equal to or higher than the first crystallization starting temperature, whereby a fine crystal structure can be generated. The first crystallization starting temperature is a temperature at which a crystal phase having a body-centered cubic structure starts to form when an amorphous phase having a chemical composition constituting the soft magnetic alloy particles is heated from room temperature. The first crystallization starting temperature depends on the heating temperature rising rate, and the first crystallization starting temperature increases as the heating temperature rising rate increases, and the first crystallization starting temperature decreases as the heating temperature rising rate decreases. When the crystal phase having a body-centered cubic structure is sufficiently generated, the saturation magnetic flux density improves, and the coercive force decreases.

Subsequently, it is preferable to further perform a step of forming the second film containing an oxide on the surface of the first film.

The method for forming the second film is not particularly limited, and a sol-gel method may be used for forming a uniform and strong film.

The blending amount of the compound constituting the second film (hereinafter, also referred to as a compound for the second film) is preferably 0.10 wt% or more and preferably 0.50 wt% or less (i.e., from 0.10 wt% to 0.50 wt%) with respect to 100 wt% of the soft magnetic alloy particles.

The step of forming the second film may be performed by, for example, a method of mixing a solution containing the compound for the second film or a precursor thereof and the coated soft magnetic alloy particles on which the first film is formed, and heating and drying the mixture.

### Dust Core

The dust core of the present disclosure includes the coated soft magnetic alloy particle of the present disclosure.

The dust core of the present disclosure can be used for magnetic application components such as motors, reactors, inductors, and various coils.

The dust core may be produced by kneading a binder dissolved in a solvent and the coated soft magnetic alloy particles, filling the mixture in a mold, and applying a pressure. The resin constituting the binder is not particularly limited and may be a thermosetting resin such as an epoxy resin, a phenol resin, or a silicon resin, or may be a mixture of a thermoplastic resin and a thermosetting resin. It is possible to cause the molded dust core to have increased mechanical strength by drying an extra solvent and then heating the dust core.

As a condition of the powder molding, a conventionally known method may be employed, and for example, the powder molding is preferably performed at 250° C. or less, 0.1 MPa or more and 800 MPa or less (i.e., from 0.1 MPa to 800 MPa).

A heat treatment may be performed to relax the distortion of the coated soft magnetic alloy particles introduced by the pressure during molding. The distortion easily relaxes for example when a heat treatment is performed at a temperature of 300° C. or more and 450° C. or less (i.e., from 300° C. to 450° C.) under a condition in which the resin is not burned or volatilized to adversely affect magnetic characteristics.

Since the dust core of the present disclosure uses the coated soft magnetic alloy particle of the present disclosure, the space filling rate of the soft magnetic particles is increased. Thus, it is possible to form a coil having a high magnetic permeability and a high saturation magnetic flux density.

### Magnetic Application Component

The magnetic application component of the present disclosure includes the coated soft magnetic alloy particle of the present disclosure or includes the dust core of the present disclosure.

Examples of the magnetic application component include motors, reactors, inductors, and various coils. For example, a coil in which a conductive wire is wound around a dust core is exemplified.

FIG. 4 is a perspective view schematically illustrating an example of a coil as the magnetic application component.

A coil 100 illustrated in FIG. 4 includes a dust core 110 containing the coated soft magnetic alloy particle of the present disclosure, and a primary wire 120 and a secondary wire 130 wound around the dust core 110. In the coil 100 illustrated in FIG. 4, the primary wire 120 and the secondary wire 130 are bifilarly wound around the dust core 110 having an annular toroidal shape.

The structure of the coil is not limited to the structure of the coil 100 illustrated in FIG. 4. For example, one wire may be wound around a dust core having an annular toroidal shape. A structure including an element body containing the coated soft magnetic alloy particle of the present disclosure and a coil conductor embedded in the element body may also be employed.

Since the coil as the magnetic application component of the present disclosure has a high space filling rate of soft magnetic particles in the dust core, the coil has a high magnetic permeability and a high saturation magnetic flux density.

### Examples

Hereinafter, Examples more specifically disclosing the present disclosure will be described. The present disclosure is not limited only to these Examples.

### Example 1

The raw materials were weighed so as to satisfy the chemical composition formula: Fe_{84.2}Si₁B9C₁P₃Cu_{0.8}Sn₁. The total weight of the raw materials was 150 g. As the raw material of Fe, MAIRON (purity: 99.95%) manufactured by Toho Zinc Co., Ltd. was used. As the raw material of Si, granular silicon (purity: 99.999%) manufactured by Kojundo Chemical Laboratory Co.,Ltd. was used. As the raw material of B, granular boron (purity: 99.5%) manufactured by Kojundo Chemical Laboratory Co.,Ltd. was used. As the raw material of C, powdered graphite (purity: 99.95%) manufactured by Kojundo Chemical Laboratory Co.,Ltd. was used. As the raw material of P, aggregated iron phosphide Fe₃P (purity: 99%) manufactured by Kojundo Chemical Laboratory Co.,Ltd. was used. As the raw material of Cu, chip-shaped copper (purity: 99.9%) manufactured by Kojundo Chemical Laboratory Co.,Ltd. was used. As the raw material of Sn, granular tin (purity: 99.9%) manufactured by Kojundo Chemical Laboratory Co.,Ltd. was used.

The raw materials were filled in an alumina crucible (U1 material) manufactured by TEP Corporation, heated by induction heating until the sample temperature reached 1300° C., and held for 1 minute to be dissolved. The dissolving atmosphere was argon. The molten metal obtained by dissolving the raw materials was poured into a copper mold and cooled and solidified to obtain a mother alloy. The mother alloy was pulverized into a size of about 3 mm to 10 mm with a jaw crusher. Next, the pulverized mother alloy was processed into a ribbon with a single roll liquid quenching apparatus. Specifically, 15 g of the mother alloy was filled in a nozzle made of quartz material and melted by heating to 1200° C. by induction heating in an argon atmosphere. The molten metal obtained by dissolving the mother alloy was supplied to a surface of a cooling roll made of copper to obtain a ribbon having a thickness of 15 µm to 25 µm and a width of 1 mm to 4 mm. The molten steel outflow gas pressure was 0.015 MPa. The hole diameter of the quartz nozzle was 0.7 mm. The circumferential velocity of the cooling roll was 50 m/s. The distance between the cooling roll and the quartz nozzle was 0.27 mm.

The obtained ribbon was pulverized using a sample mill SAM manufactured by NARA Machinery Co., Ltd. The rotation speed of SAM was 15,000 rpm.

The pulverized powder obtained by pulverization with SAM was subjected to a spheroidizing treatment using a high-speed rotary pulverizer. As the high-speed rotary pulverizer, a hybridization system NHS-0 type manufactured by NARA Machinery Co., Ltd. was used. The rotation speed was 13,000 rpm, and the treatment time was 30 minutes.

The pulverized powder subjected to the spheroidizing treatment was passed through a sieve with a mesh size of 38 µm, and coarse particles remaining on the sieve were removed. Next, the powder was passed through a sieve with a mesh size of 20 µm to remove fine particles passing through the sieve, and soft magnetic alloy particles remaining on the sieve were collected.

Next, the first film was formed on the soft magnetic alloy particles by the following procedure.

Molybdenum disulfide particles in an amount of 0.24 g were mixed with 40 g of the soft magnetic alloy particles collected by classification with the sieves. The blending amount of molybdenum disulfide with respect to 100 wt% of the soft magnetic alloy particles is 0.60 wt%. The average particle size of the molybdenum disulfide particles is 500 nm or less.

The mixed powder was treated by a mechanofusion process to form the first film. The apparatus used was NOB-MINI manufactured by Hosokawa Micron Corporation, the rotation speed was set to 6,000 rpm, and the processing time was set to 30 minutes.

Thereafter, the soft magnetic alloy particles were subjected to a heat treatment at a temperature 20° C. higher than the first crystallization starting temperature of the soft magnetic alloy particles to generate nanocrystals from the amorphous phase.

As a heat treatment furnace, an infrared lamp annealing furnace RTA manufactured by ADVANCE RIKO, Inc. was used. The heat treatment atmosphere was argon, and carbon was used as an infrared susceptor. A sample in an amount of 2 g was placed on a carbon susceptor having a diameter of 4 inches, and a carbon susceptor having a diameter of 4 inches was further placed thereon. A control thermocouple was inserted into a thermocouple insertion hole formed in the lower carbon susceptor. The temperature rising rate was 400° C./min. The holding time at the heat treatment temperature was 1 minute. The cooling was natural cooling, and the temperature reached 100° C. or less in approximately 30 minutes.

The first crystallization starting temperature was measured with a differential scanning calorimeter (DSC404F3 manufactured by Netsch). The temperature was raised from room temperature to 650° C. under the condition of 20° C./min, and the heat generation of the sample at each temperature was measured. Platinum was used as a sample container. Argon (99.999%) was selected as an atmosphere, and the gas flow rate was 1 L/min. The amount of the sample was 15 mg to 20 mg. The intersection of the tangent line of the DSC curve at a temperature equal to or lower than the temperature at which heat generation by crystallization is started and the maximum slope tangent line at the starting of the heat generation peak of the sample by the crystallization reaction was defined as the first crystallization starting temperature.

The coated soft magnetic alloy particles were used as the coated soft magnetic alloy particles of the sample No. 1.

Subsequently, the second film was formed on the surface of the coated soft magnetic alloy particles of the sample No. 1. Isopropyl alcohol in an amount of 8.5 g, 8.5 g of 9% aqueous ammonia, and 1.14 g of 30% PLYSURF AL (phosphoric acid ester-type anionic surfactant manufactured by DKS Co. Ltd.) were mixed with 30 g of the coated soft magnetic alloy particles of the sample No. 1.

Subsequently, a mixed solution of 7.9 g of isopropyl alcohol and 2.1 g of tetraethoxysilane (TEOS) was mixed in 3 portions of 1.0 g each, and the mixture was filtered with a filter paper. The sample collected on the filter paper was washed with acetone, then heated and dried at a temperature of 80° C. for 60 minutes and subjected to a heat treatment at a temperature of 140° C. for 30 minutes to form the second film, whereby coated soft magnetic alloy particles were obtained.

The coated soft magnetic alloy particles were used as the coated soft magnetic alloy particles of the sample No. 2.

As shown in Table 1, coated soft magnetic alloy particles were produced by changing the configurations of the first film and the second film, whereby coated soft magnetic alloy particles of the sample Nos. 3, 4, and 5 were obtained.

The soft magnetic alloy particles on which neither the first film nor the second film was formed were used as the sample No. 6. In the description of the measurement method shown below, the particles of the sample No. 6 are also treated as coated soft magnetic alloy particles.

The average smoothness ζ__ave, the saturation magnetic flux density Bs, the coercive force Hc, and the powder volume resistivity of the produced sample were measured, and the results are shown in Table 1. The measurement methods are as follows.

The method for measuring the average smoothness of the coated soft magnetic alloy particles is as described herein with reference to FIG. 2. WinROOF2018 (manufactured by MITANI CORPORATION) was used as image analysis software.

The method for measuring the saturation magnetic flux density Bs is as follows.

The saturation magnetization Ms was measured with a vibrating sample type magnetization measuring instrument (VSM). A capsule for powder measurement was filled with the coated soft magnetic alloy particles and sealed so that the particles did not move when a magnetic field was applied.

The apparent density ρ was measured by a pycnometer method. The replacement gas was He.

The saturation magnetic flux density Bs was calculated from the numerical value of the saturation magnetization Ms measured with VSM and the apparent density ρ measured by the pycnometer method using the following formula (1).

$$\text{Bs = 4} π ⋅ \text{Ms} ⋅ ρ$$

The coercive force Hc was measured with a coercive force meter K-HC1000 manufactured by Tohoku Steel Co., Ltd. A capsule for powder measurement was filled with the coated soft magnetic alloy particles and sealed so that the particles did not move when a magnetic field was applied.

The powder volume resistivity was measured as a volume resistivity at 60 MPa pressurization using a powder resistivity measurement unit MCP-PD51 manufactured by Mitsubishi Chemical Analytech Co., Ltd.

Electron micrographs of the soft magnetic alloy particles (particles of the sample No. 6) before the first film and the second film are formed and the coated soft magnetic alloy particles (particles of the sample No. 2) after the first film and the second film are formed are shown. An electron micrograph of the soft magnetic alloy particles (particles in the process of producing the particles of the sample No. 1) after forming only the first film is also shown.

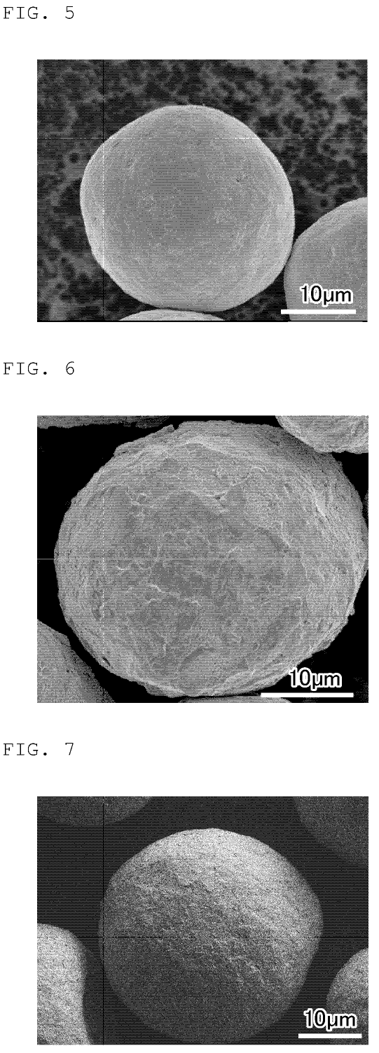

FIG. 5 is an electron micrograph of the coated soft magnetic alloy particles of the sample No. 2, and FIG. 6 is an electron micrograph of the soft magnetic alloy particles of the sample No. 6. FIG. 7 is an electron micrograph of the coated soft magnetic alloy particles of the sample No. 1.

Comparison between FIGS. 5 and 6 shows that the surface of the soft magnetic alloy particle is smoothed by forming the first film and the second film.

In addition, it can be seen from FIG. 7 that the surface of the soft magnetic alloy particle is smoothed by forming the first film.

Table 1

| Sample No. | First film | Second film | Average smoothness | Saturation magnetic flux density Bs | Coercive force Hc | Powder volume resistivity at 60 MPa |
|---|---|---|---|---|---|---|
| | Molybdenum disulfide | Silicon dioxide | | | | |
| | [wt%] | [wt%] | [ζ_ave] | [T] | [A/m] | [Ω•cm] |
| 1 | 0.60 | 0 | 0.94 | 1.670 | 90 | 6.23E-02 |
| 2 | 0.60 | 0.30 | 0.94 | 1.654 | 101 | 9.98E+04 |
| 3 | 0.35 | 0.30 | 0.92 | 1.663 | 103 | 2.52E+04 |
| *4 | 0 | 0.90 | 0.90 | 1.657 | 108 | 4.40E-02 |
| *5 | 0 | 3.10 | 0.89 | 1.620 | 123 | 3.87E+09 |
| *6 | 0 | 0 | 0.90 | 1.672 | 71 | 1.64E-03 |

In Table 1, the sample numbers marked with * are Comparative Examples outside the scope of the present disclosure. In the sample Nos. 4 and 5, only a silicon dioxide film was applied, and a molybdenum disulfide film corresponding to the first film was not applied, but this silicon dioxide film was regarded as the second film and described in Table 1.

Table 1 shows that in the sample Nos. 1, 2, and 3 that are within the scope of the present disclosure, the average smoothness ζ_ave is 0.92 or more, the saturation magnetic flux density is high, and the coercive force is low. Further, in the sample Nos. 2 and 3, the powder volume resistivity is high.

The sample No. 4 has a high coercive force and a low powder volume resistivity.

The sample No. 5 has a high powder volume resistivity but has a low saturation magnetic flux density and a high coercive force.

The sample No. 6 has a low powder volume resistivity.

### Example 2

The sample produced in Example 1 was processed into a dust core having a toroidal shape. A mixed powder in an amount of 100 wt% containing 70 wt% of the coated soft magnetic alloy particles and 30 wt% of an iron powder having an average particle size of 5 µm was mixed with 1.5 wt% of phenol resin PC-1 and 3.0 wt% of acetone in a mortar.

After acetone was volatilized under the conditions of a temperature of 80° C. and a retention time of 30 minutes in an explosion-proof oven, the sample was filled in a mold and formed into a toroidal shape having an outer diameter of 8 mm and an inner diameter of 4 mm by hot molding at a pressure of 60 MPa and a temperature of 180° C. to produce a dust core.

Next, the filling rate Pr of the dust core was determined. The outer diameter φo and the inner diameter φi of the dust core were measured at three points with a caliper, and the average value was calculated. The thickness t of the magnetic core was measured at three points using a micrometer, and the volume Vc of the dust core was determined using the formula (2).

The weight m of the sample was measured with an electronic balance, and the packing density ρc of the dust core was determined by the formula (3).

The apparent density of the mixed powder was defined as ρm, and the filling rate Pr of the dust core was determined by the formula (4).

$${V}_{c} = \left(\frac{{∅}_{0}^{2} - {∅}_{i}^{2}}{4}\right) ⋅ π ⋅ t$$

$${ρ}_{c} = \frac{m}{{V}_{c}}$$

$${P}_{r} = \frac{{ρ}_{c}}{{ρ}_{m}} \times 100 \left(\%\right)$$

The relative initial magnetic permeability of the dust core was measured with an impedance analyzer E4991A and a magnetic material test fixture 16454A manufactured by Keysight Technologies.

Copper wires were wound around the dust core to measure the iron loss. The diameter of the copper wire was 0.26 mm. The number of turns of the primary wire for excitation and the number of turns of the secondary wire for detection were the same as 20 turns, and bifilar winding was performed. The frequency condition was 100 kHz, and the maximum magnetic flux density was 20 mT.

The filling rate Pr, the relative initial magnetic permeability, and the iron loss of the toroidal dust core using each sample produced in Example 1 are shown in Table 2. The correspondence relationship between Example 1 and Example 2 is as follows: Sample 1 → Sample 7, Sample 2 → Sample 8, Sample 3 → Sample 9, Sample 4 → Sample 10, Sample 5 → Sample 11, and Sample 6 → Sample 12.

Table 2

| Sample No. | Filling rate Pr of dust core | Relative initial magnetic permeability | Iron loss |
|---|---|---|---|
| | [%] | [-] | [kW/m³] |
| 7 | 80.0 | 29.8 | 45.54 |
| 8 | 80.4 | 29.1 | 19.03 |
| 9 | 79.4 | 28.1 | 25.67 |
| *10 | 77.6 | 25.9 | 78.68 |
| *11 | 74.6 | 12.7 | 43.46 |
| *12 | 77.3 | 24.0 | 128.62 |

In Table 2, the sample numbers marked with * are Comparative Examples outside the scope of the present disclosure.

Table 2 shows that in the sample Nos. 7, 8, and 9 that are within the scope of the present disclosure, the dust core has a high filling rate Pr (space filling rate), a high relative initial magnetic permeability, and a low iron loss.

In all of the sample Nos. 10, 11, and 12, the filling rate Pr of the dust core is low, and the relative initial magnetic permeability is low. Further, in the sample Nos. 10 and 12, the iron loss is high.

What is claimed is:

1. A coated soft magnetic alloy particle comprising:
a soft magnetic alloy particle containing an amorphous phase; and
a first film containing at least one compound selected from the group consisting of an inorganic compound having a hexagonal, trigonal, or monoclinic crystal structure and a layered silicate mineral,
the first film coating a surface of the soft magnetic alloy particle, and
an outer peripheral contour of the coated soft magnetic alloy particle in a cross-sectional view having an average smoothness ζ_ave of from 0.92 to 1.00.

2. The coated soft magnetic alloy particle according to claim 1, further comprising:
a second film containing an oxide, the second film coating a surface of the first film.

3. The coated soft magnetic alloy particle according to claim 2, wherein
the second film contains silicon dioxide.

4. The coated soft magnetic alloy particle according to claim 1, wherein
the soft magnetic alloy particle has a chemical composition represented by FeₐSi_{b}B_{c}C_{d}PₑCu_{f}Sn_{g}M1ₕM2ᵢ,
where M1 is one or more elements of Co and Ni,
M2 is one or more elements of Ti, Zr, Hf, Nb, Ta, Mo, W, Cr, Al, Mn, Ag, V, Zn, As, Sb, Bi, Y, and a rare earth element, and
$$79 \leq \text{a +} \text{} \text{h + i} \leq \text{86,}$$
$$0 \leq \text{b} \leq \text{5,}$$
$$4 \leq \text{c} \leq \text{13,}$$
$$0 \leq \text{d} \leq \text{3,}$$
$$5 \leq \text{c + d} \leq \text{14,}$$
$$\text{1} \leq \text{e} \leq \text{10,}$$
$$\text{0} \text{.4} \leq \text{f} \leq \text{2,}$$
$$0.3 \leq \text{g} \leq 6 ,$$
$$0 \leq \text{h} \leq \text{30,}$$
$$0 \leq \text{i} \leq 5 \text{,}$$
and
$$\text{a + b + c + d + e + f + g + h + i = 100}$$
(parts by mol) are satisfied.

5. The coated soft magnetic alloy particle according to claim 1, wherein the first film contains molybdenum disulfide.

6. A dust core comprising the coated soft magnetic alloy particle according to claim 1.

7. A magnetic application component comprising the coated soft magnetic alloy particle according to claim 1.

8. A magnetic application component comprising the dust core according to claim 6.

9. The coated soft magnetic alloy particle according to claim 2, wherein
the soft magnetic alloy particle has a chemical composition represented by FeₐSi_{b}B_{c}C_{d}PₑCu_{f}Sn_{g}M1ₕM2ᵢ,
where M1 is one or more elements of Co and Ni,
M2 is one or more elements of Ti, Zr, Hf, Nb, Ta, Mo, W, Cr, Al, Mn, Ag, V, Zn, As, Sb, Bi, Y, and a rare earth element, and
$$79 \leq \text{a + h + i} \leq \text{86,}$$
$$0 \leq \text{b} \leq \text{5,}$$
$$4 \leq \text{c} \leq \text{13,}$$
$$0 \leq \text{d} \leq \text{3,}$$
$$5 \leq \text{c + d} \leq \text{14,}$$
$$1 \leq \text{e} \leq \text{10,}$$
$$0.4 \leq \text{f} \leq \text{2,}$$
$$0.3 \leq \text{g} \leq \text{6,}$$
$$0 \leq \text{h} \leq \text{30,}$$
$$0 \leq \text{i} \leq \text{5,}$$
and
$$\text{a + b + c + d + e + f + g + h + i = 100}$$
(parts by mol) are satisfied.

10. The coated soft magnetic alloy particle according to claim 3, wherein
the soft magnetic alloy particle has a chemical composition represented by FeₐSi_{b}B_{c}C_{d}PₑCu_{f}Sn_{g}M1ₕM2ᵢ,
where M1 is one or more elements of Co and Ni,
M2 is one or more elements of Ti, Zr, Hf, Nb, Ta, Mo, W, Cr, Al, Mn, Ag, V, Zn, As, Sb, Bi, Y, and a rare earth element, and
$$79 \leq \text{a + h + i} \leq \text{86,}$$
$$0 \leq \text{b} \leq \text{5,}$$
$$4 \leq \text{c} \leq \text{13,}$$
$$0 \leq \text{d} \leq 3 ,$$
$$5 \leq \text{c} \text{+} \text{d} \leq \text{14,}$$
$$1 \leq \text{e} \leq 10 ,$$
$$0.4 \leq \text{f} \leq \text{2,}$$
$$0.3 \leq \text{g} \leq 6 \text{,}$$
$$0 \leq \text{h} \leq \text{30,}$$
$$0 \leq \text{i} \leq \text{5,}$$
and
$$\text{a + b + c + d + e + f + g + h + i = 100}$$
(parts by mol) are satisfied.

11. The coated soft magnetic alloy particle according to claim 2, wherein
the first film contains molybdenum disulfide.

12. The coated soft magnetic alloy particle according to claim 3, wherein
the first film contains molybdenum disulfide.

13. The coated soft magnetic alloy particle according to claim 4, wherein
the first film contains molybdenum disulfide.

14. A dust core comprising the coated soft magnetic alloy particle according to claim 2.

15. A dust core comprising the coated soft magnetic alloy particle according to claim 3.

16. A dust core comprising the coated soft magnetic alloy particle according to claim 4.

17. A dust core comprising the coated soft magnetic alloy particle according to claim 5.

18. A magnetic application component comprising the coated soft magnetic alloy particle according to claim 2.

19. A method for producing a coated soft magnetic alloy particle, the method comprising:
preparing a soft magnetic alloy particle; and
forming a first film on a surface of the soft magnetic alloy particle by mixing the soft magnetic alloy particle with at least one compound selected from the group consisting of an inorganic compound having a hexagonal, trigonal, or monoclinic crystal structure and a layered silicate mineral to form a mixture and treating the mixture by a mechanofusion process.

20. The method for producing a coated soft magnetic alloy particle according to claim 19, further comprising:
forming a second film containing an oxide on a surface of the first film.
